(19) United States
(12) Patent Application Publication
(10) Pub. No.: US 2010/0209677 A1
(43) Pub. Date: Aug. 19, 2010

(54) IMAGE RECORDING METHOD, RECORD AND IMAGE RECORDING SYSTEM

(75) Inventors: Tsuyoshi SANO, Shiozini-shi (JP); Seishin Yoshida, Azumino-shi (JP); Kiyohiko Takemoto, Matsumoto-shi (JP)

Correspondence Address: LADAS & PARRY LLP, 26 WEST 61ST STREET, NEW YORK, NY, 10023, US

(73) Assignee: SEIKO EPSON CORPORATION

(21) Appl. No.: 12/633,938

(22) Filed: Dec. 9, 2009

(30) Foreign Application Priority Data
Dec. 9, 2008 (JP) 2008-312995
Nov. 30, 2009 (JP) 2009-271229

(51) Int. Cl. B32B 3/10; B05D 1/36; B05D 5/00; B05C 5/00; B05D 5/06

(52) U.S. Cl. 428/195.1; 427/258; 427/265; 118/300

(57) ABSTRACT

[Problems] There is provided an image recording method that provides resulting images with an excellent gloss and an improved closeness of contact with the recording medium used.

[Solving Means] An image recording method including a first step for recording a glossy image layer on a recording medium using a glossy ink composition containing a metal pigment and a second step for recording a finishing layer on the glossy image layer using a black ink composition to reduce the brightness of the glossy image.

### BACKGROUND OF THE INVENTION

1. Technical Field

The present invention relates to an image recording method that provides resulting images with an excellent gloss (metallic luster) and an improved closeness of contact with the recording medium used, and it also relates to an image provided therewith. Also, the present invention relates to an image recording system that provides images with an excellent gloss and an improved closeness of contact with the recording medium used.

2. Related Art

To produce glossy images on recording media, printing ink containing gold dust or silver dust made from brass, aluminum fine particles, and other materials as a pigment, stamping based on the use of metal foil, thermal transfer based on the use of metal foil, and other methods have conventionally been used.

However, when coatings are produced using printing ink containing gold dust or silver dust, the average particle diameter of the metal powder used is as large as 10 μm to 30 μm, and thus matt images can be obtained, but it is difficult to obtain a mirror luster. Also, when stamping or thermal transfer based on the use of metal foil is employed, the method used is as follows: an adhesive agent is applied to a recording medium, a smooth sheet of metal foil is pressed against the adhesive agent applied, and then the recording medium and the metal foil sheet are heated while being kept in contact with each other so that they are fused together. As a result, a relatively favorable luster is obtained; however, recording media allowed are limited to ones resistant to heat and deformation because of the large number of manufacturing steps and pressure and heat applied during the manufacturing process. Known techniques for producing glossy images on recording media are described in, for example, Patent Documents 1 and 2 listed below.

Recently, the use of ink jet in printing has also often been seen, and one of examples thereof is metallic printing (for example, see Patent Documents 3 and 4 listed below).

However, these known techniques have a problem of low closeness of contact (adhesiveness) between the resulting glossy image, which is produced using a glossy ink composition containing a metal pigment, and the recording medium used, and thus images produced therewith are inferior in resistance to friction (in other words, the metal pigments are likely to be peeling). Furthermore, glossy images produced with the known techniques have insufficient gloss and thus have room for improvement.

### [Prior Publications]

### [Patent Documents]

[Patent Document 1] Japanese Unexamined Patent Application Publication No. H11-320935

[Patent Document 2] Japanese Unexamined Patent Application Publication No. 2006-50347

[Patent Document 3] Japanese Unexamined Patent Application Publication No. 2002-179960

[Patent Document 4] Japanese Unexamined Patent Application Publication No. 2008-208330

### SUMMARY OF THE INVENTION

### Problems to be Solved by the Invention

An object of the present invention is to provide an image recording method that provides the resulting images with an excellent gloss and an improved closeness of contact with the recording medium used.

Another object of the present invention is to provide an image recording system that provides images with an excellent gloss and an improved closeness of contact with the recording medium used.

### Means for Solving the Problems

The present inventors have conducted extensive research to solve the above-described problems and found the following: a glossy image layer is produced using a glossy ink composition containing a metal pigment (e.g., plate-like aluminum particles), and then a coating layer (a finishing layer) is produced on this glossy image layer using a black ink composition that contains carbon black or some other black pigment at a low proportion so that the brightness of the glossy image layer be reduced; this further improves the gloss of the glossy image layer. This is probably because the surface properties (surface uniformity) of the glossy image are changed by the black pigment attached to the glossy image, which has a metallic luster, at a density low enough to keep the black pigment invisible.

Additionally, the present invention contains a resin for fixing the black pigment in the black ink composition, which forms the coating layer; this allows the lower layer, namely, the glossy image layer, to have an improved adhesiveness.

Thus, the present invention is based on the above-described findings and is as follows.

(1) An image recording method including a first step for recording a glossy image layer on a recording medium using a glossy ink composition containing a metal pigment and a second step for recording a finishing layer on the glossy image layer using a black ink composition to reduce the brightness of the glossy image.

(2) The image recording method according to (1), wherein the concentration of pigment of the black ink composition is equal to or lower than 1 mass %.

(3) The image recording method according to (2), wherein the concentration of pigment of the black ink composition is in the range of 0.1 to 0.5 mass.

(4) The image recording method according to any one of (1) to (3), wherein the black ink composition contains a water-soluble resin.

(5) The image recording method according to (4), wherein the concentration of the water-soluble resin in the black ink composition is at least 20-fold greater than the concentration of pigment of the black ink composition on the solid content basis.

(6) The image recording method according to any one of (1) to (5), wherein the finishing layer is formed on at least a partial surface of the glossy image layer.

(7) The image recording method according to (6), wherein the finishing layer is formed on the entire surface of the glossy image layer.

(8) The image recording method according to any one of (1) to (7) performed using an ink jet recording method.

(9) A record obtained using the image recording method according to any one of (1) to (8).

(10) An image recording system having glossy image formation means for recording a glossy image layer on a recording medium using a glossy ink composition containing a metal pigment and finishing layer formation means for recording a finishing layer on the glossy image layer using a black ink composition to reduce the brightness of the glossy image.

### ADVANTAGES

The image recording method according to the present invention provides the resulting images with an excellent gloss and an improved closeness of contact with the recording medium used.

Recently, there has been an increasing demand for spot varnish, which is an expression style involving a partial change in the surface properties of prints or other records. The image recording method according to the present invention can form a partial finishing layer, thereby allowing for the easier production of a glossy image with position-specific gloss.

### BEST MODE FOR CARRYING OUT THE INVENTION

### Image Recording Method

The image recording method according to the present invention includes a first step for recording a glossy image layer on a recording medium using a glossy ink composition containing a metal pigment and a second step for recording a finishing layer on the glossy image layer using a black ink composition to reduce the brightness of the glossy image.

First, the glossy ink composition used in the present invention is described.

The metal pigment (or metallic pigment) is desirably plate-like particles and is preferably a metal pigment meeting the following conditions: the 50% average particle diameter R50 based on the circle-equivalent diameter calculated from the area of the X-Y plane of a plate-like particle is in the range of 0.5 to 3 μm, and R50/Z>5, where X, Y, and Z represent the planar length, planar width, and thickness of the plate-like particle.

The “plate-like particles” refer to particles having an almost flat plane (X-Y plane) and an almost uniform thickness (Z). Such plate-like particles are produced by pulverizing a metal-deposited film, and thus the metal particles obtained have an almost flat plane and an almost uniform thickness. Thus, the planar length, planar width, and thickness of a plate-like particle can be defined as X, Y, and Z, respectively.

The “circle-equivalent diameter” is a diameter of a circle calculated by supposing that the almost flat plane (X-Y plane) of each plate-like particle contained in the metallic pigment is a circle having the same projected area as the plate-like particle of the metallic pigment. For example, when the almost flat plane (X-Y plane) of each plate-like particle contained in the metallic pigment is a polygon, the diameter of the circle obtained by converting the surface of projection of the polygon into a circle is the circle-equivalent diameter of the plate-like particles contained in the metallic pigment.

From the viewpoints of gloss and printing stability, the above-described 50% average particle diameter R50 based on the circle-equivalent diameter calculated from the area of the X-Y plane of a plate-like particle is preferably in the range of 0.5 to 3 μm, more preferably, 0.75 to 2 μm.

As for the relationship between the above-described 50% average particle diameter R50 based on the circle-equivalent diameter and the thickness Z, R50/Z is preferably more than 5 from the viewpoint of ensuring a high gloss.

From the viewpoints of cost and ensuring gloss, the above-described metallic pigment preferably is aluminum or an aluminum alloy. When an aluminum alloy is used, every kind of glossy metallic or non-metallic element may be alloyed with aluminum without particular limitation, and examples thereof include silver, gold, platinum, nickel, chromium, tin, zinc, indium, titanium, copper, and so forth. One or more of these elements, their alloys, and their mixtures can be suitably used.

The manufacturing method of this metallic pigment is, for example, as follows: a composite pigment bulk having a structure obtained by layering a sheet-like substrate, a resin release layer, and a metal or alloy layer is separated into two parts at the interface between the metal or alloy layer and the resin release layer, and then the metal or alloy layer is pulverized into fine plate-like particles; then, the plate-like particles obtained are screened so that ones meeting the following conditions can be chosen: the 500 average particle diameter R50 based on the circle-equivalent diameter calculated from the area of the X-Y plane of a plate-like particle is in the range of 0.5 to 3 μm, and R50/Z>5, where X, Y, and Z represent the planar length, planar width, and thickness of the plate-like particle.

The planar length X, planar width Y, and circle-equivalent diameter of the above-described metallic pigment (plate-like particles) can be measured using a particle image analyzer. Examples of particle image analyzers used include FPIA-2100, FPIA-3000, and FPIA-3000S flow particle image analyzers manufactured by Sysmex Corporation.

The above-described metal or alloy layer is preferably formed by vacuum evaporation, ion plating, or sputtering.

This metal or alloy layer is formed with a thickness in the range of 20 nm to 100 nm, both inclusive. As a result, a pigment having an average thickness in the range of 20 nm to 100 nm, both inclusive, is obtained. With an average thickness of not less than 20 nm, the metallic pigment would have higher performances such as excellent reflectance and gloss. With an average thickness of not more than 100 nm, the metallic pigment would be guaranteed dispersion stability with the increase in apparent specific gravity prevented.

The resin release layer contained in the above-described composite pigment bulk is not only an undercoat layer for the above-described metal or alloy layer but also a release layer that makes the metal or alloy layer easier to remove from the sheet-like substrate. Examples of preferred resins for this resin release layer include polyvinyl alcohol, polyvinyl butyral, polyethylene glycol, polyacrylic acid, polyacrylamide, cellulose derivatives, polyvinyl butyral, acrylic-acid-based polymers, and modified nylon resins.

The solution of one of the above-listed resins or that of a mixture of two or more of the resins is applied to a recording medium, and then the recording medium is dried and subjected to other treatments, yielding a layer; after being applied, it may be spiked with additives, such as a viscosity modifier.

This resin release layer can be applied by any of commonly used methods including gravure coating, roll coating, blade coating, extrusion coating, dip coating, spin coating, and so forth. After being applied and dried, the resin release layer may be calendered for surface smoothness, if necessary.

Although not particularly limited, the thickness of the resin release layer is preferably in the range of 0.5 to 50 μm, more preferably, 1 to 10 μm. With a thickness of less than 0.5 the resin release layer would fail to meet a quantitative requirement for serving as dispersion resin. With a thickness of more than 50 μm, the resin release layer would be likely to be peeling at the interface with the pigment layer when the composite pigment bulk is rolled.

Examples of the sheet-like substrate include, but not limited to, releasable films such as polyester films made of polytetrafluoroethylene, polyethylene, polypropylene, polyethylene terephthalate, or the like, polyamide films made of 6,6-nylon, 6-nylon, or the like, polycarbonate films, triacetate films, and polyimide films. Ones made of polyethylene terephthalate or its copolymer are preferable.

Although not particularly limited, the thickness of this sheet-like substrate is preferably in the range of 10 to 150 μm. With a thickness of not less than 10 μm, the sheet-like substrate would be handled during relevant steps or processes without any problems. With a thickness of not more than 150 μl, the sheet-like substrate is highly flexible and thus can be rolled, removed, or handled in other ways without any problems.

As described in Japanese Unexamined Patent Application Publication No. 2005-68250, the above-described metal or alloy layer may be sandwiched between protective layers. Examples of protective layers used include silicon oxide layers and protective resin layers.

No particular limitation is imposed on the silicon oxide layers used as long as they are layers containing silicon oxide; however, they are preferably made by the sol-gel method from a silicon alkoxide, such as tetraalkoxysilane, or its polymer.

The silicon oxide layers are formed by applying an alcohol solution of the silicone alkoxide or its polymer and then heating and firing the coatings obtained.

Also on the protective resin layers, no particular limitation is imposed as long as they are insoluble in the dispersion medium used. Examples of materials for them include polyvinyl alcohol, polyethylene glycol, polyacrylic acid, polyacrylamide, cellulose derivatives, and so forth; preferred ones include polyvinyl alcohol and cellulose derivatives.

An aqueous solution of one of the above-listed resins or that of a mixture of two or more of the resins is applied, thereby yielding a layer that has been dried and subjected to other treatments. The application solution may contain additives, such as a viscosity modifier.

The above-described silicon oxide or resin is applied by the same method as that for the resin release layer described above.

Although not particularly limited, the thickness of each protective film is preferably in the range of 50 to 150 nm. With a thickness of less than 50 nm, the protective films would lack mechanical strength. With a thickness of more than 150 nm, the protective films would have excessive strength and thus is difficult to pulverize or disperse; in some cases, such films are peeling at the interfaces with the metal or alloy layer.

In addition, a colorant layer may be disposed between each protective layer and the metal or alloy layer.

The colorant layer is introduced to color the composite pigment. No particular limitation is imposed on the colorant layer used as long as it contains a pigment that maintains the metallic pigment glossy and gives any intended hue and tone to the metallic pigment. The colorant for this colorant layer may be a dye or a pigment. Any known dye or pigment can be used, if it is appropriate.

The “pigment” for this colorant layer is a natural pigment, a synthetic organic pigment, a synthetic inorganic pigment, or some other pigment following the usual definition thereof in the field of pigment chemistry and thus is different from ones having a layered structure, such as the “composite pigment” used in the present invention.

Although not particularly limited, the method for forming this colorant layer is preferably coating.

When the colorant contained in the colorant layer is a pigment, it preferably further contains a colorant dispersion resin. The colorant dispersion resin preferably has the form of thin film prepared in the following way: the pigment, the colorant dispersion resin, necessary additives, and other necessary ingredients are dispersed or dissolved in a solvent, the solution obtained is applied by coating to form a uniform liquid film, and then the liquid film is dried.

Note that in the production of the above-described composite pigment bulk, it is preferable in terms of operating efficiency that the above-described colorant layer and protective layers be all formed by coating.

The above-described composite pigment bulk may have a plurality of the above-described layered structures, each of which contains the resin release layer and the metal or alloy layer. In this case, the total thickness of the layered structures organized by the metal or alloy layers, namely, the thickness excluding those of the sheet-like substrate and the overlying resin release layer, in other words, the thickness of the “metal or alloy layer/resin release layer/metal or alloy layer” or that of the “resin release layer/metal or alloy layer,” is preferably equal to or smaller than 5000 nm. With a thickness of not more than 5000 nm, the composite pigment bulk would hardly crack or be peeling even when rolled and thus would be excellent in terms of storage stability. Additionally, such a composite pigment bulk maintains gloss even when used as a pigment and thus is favorable.

In addition, the composite pigment bulk can have a structure in which the resin release layer and the metal or alloy layer are layered on the individual faces of the sheet-like substrate. Anyway, the structure of the composite pigment bulk is never limited to those described above.

Although not particularly limited, the method for separating the composite pigment and the sheet-like substrate is preferably one in which the above-described composite pigment bulk is immersed in a liquid or one in which the composite pigment bulk is immersed in a liquid under ultrasonic treatment for the pulverization of the composite pigment simultaneous with the removal of the sheet-like substrate.

In the pigment obtained in this way, the resin release layer acts as protective colloid; thus, such a pigment gives a stable dispersion upon being dispersed in a solvent. Additionally, ink compositions containing such a pigment can adhere to paper or some other kind of recording medium thanks to the resin used in this resin release layer.

The glossy ink composition used in the present invention preferably contains the above-described metallic pigment, an organic solvent, and a resin.

The concentration of the above-described metallic pigment in the ink composition is preferably in the range of 0.1 to 10 mass %.

When the concentration of the above-described metallic pigment in the ink composition is not less than 0.1 mass % and less than 1.5 mass %, ejecting ink at an amount incapable of sufficiently covering a printing surface would make it possible to print a texture that has a half-mirror-like glossy surface, or offers gloss, and, at the same time, has a see-through appearance, whereas ejecting ink at an amount capable of sufficiently covering the printing surface would make it possible to produce a metallic gloss surface that is highly glossy. Thus, such an ink composition can be suitably used to, for example, produce a half-mirror image or produce a highly glossy metallic gloss surface on a transparent recording medium. When the concentration of the metallic pigment in the ink composition is in the range of 1.5 mass % to 3.0 mass %, both inclusive, particles in the metal pigment are randomly arranged on a printing surface, and thus the resulting metallic gloss surface is not highly glossy, but matt. Thus, such an ink composition can be suitably used to, for example, coat a transparent recording medium with a shield layer.

The above-mentioned organic solvent is preferably a polar organic solvent. Examples include alcohols (e.g., methyl alcohol, ethyl alcohol, propyl alcohol, butyl alcohol, isopropyl alcohol, and fluorinated alcohols), ketones (e.g., acetone, methyl ethyl ketone, and cyclohexanone), carboxylic acid esters (e.g., methyl acetate, ethyl acetate, propyl acetate, butyl acetate, methyl propionate, and ethyl propionate), ethers (e.g., diethyl ether, dipropyl ether, tetrahydrofuran, and dioxane), and so forth.

It is particularly preferable that this organic solvent contain one or more kinds of alkylene glycol ethers that are liquid at room temperature and pressure.

Alkylene glycol ethers are mainly composed of any one of aliphatic groups such as methyl, n-propyl, i-propyl, n-butyl, i-butyl, hexyl, and 2-ethylhexyl groups, an allyl group, which has a double bond, and a phenyl group and can be classified into ethylene glycol ethers and propylene glycol ethers. They are colorless and almost odorless, and their molecules contain ether and hydroxyl groups; thus, such ethers behave both as alcohol and ether and are liquid at room temperature. These ethers can be further classified into monoethers, which have one of the two hydroxyl groups substituted, and diethers, which have both the hydroxyl groups substituted. Monoethers and diethers can be used in combination of two or more kinds.

A particularly preferred example of this organic solvent is a mixture of an alkylene glycol diether, an alkylene glycol monoether, and a lactone.

Examples of alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethyelene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, dipropylene glycol monoethyl ether, and so forth.

Examples of alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and so forth.

Examples of lactones include γ-butyrolactone, δ-valerolactone, ε-caprolactone, and so forth.

Such a preferred configuration would better guarantee the achievement of objects of the present invention.

Examples of resins for the glossy ink composition include acrylic resins, styrene-acrylic resins, rosin-modified resins, terpene resins, polyester resins, polyamide resins, epoxy resins, polyvinyl chloride resins, vinyl chloride-vinyl acetate copolymers, fiber-based resin (e.g., cellulose acetate butyrate and hydroxypropylcellulose), polyvinyl butyral, polyacrylic polyol, polyvinyl alcohol, polyurethane, and so forth.

A non-aqueous emulsion of polymer fine particles (NAD=Non Aqueous Dispersion) may also be used as the resin. This is a dispersion that contains fine particles of a polyurethane resin, an acrylic resin, an acrylic polyol resin, or the like dispersed in an organic solvent in a stable manner. Examples of those containing a polyurethane resin include Sanprene IB-501 and Sanprene IB-F370, manufactured by Sanyo Chemical Industries, Ltd. Examples of those containing an acrylic polyol resin include N-2043-60MEX and N-2043-AF-1, manufactured by Harima Chemicals, Inc.

To further improve the adhesiveness of the pigment to recording media, such a resin emulsion is added to the glossy ink composition, preferably at a concentration in the range of 0.1 mass to 10 mass %, both inclusive. With an excessive amount of the resin emulsion, the resulting glossy ink composition would lack printing stability. With an insufficient amount of the resin emulsion, the resulting glossy ink composition would have an insufficient adhesiveness.

The above-described glossy ink composition preferably contains at least one material selected from glycerin, polyalkylene glycols, and saccharides. As for the total amount of the material(s), selected from glycerin, polyalkylene glycols, and saccharides, they are added preferably at a concentration in the range of 0.1 mass to 10 mass %, both inclusive.

Such a preferred configuration would raise the quality of images on resulting records by preventing the ink from being dried and thereby preventing clogging while stabilizing the ejection of the ink.

Polyalkylene glycols are linear polymers whose backbone is organized by repeating units linked to each other via ether bonds; it can be produced by, for example, ring-opening polymerization of a cyclic ether.

Specific examples of polyalkylene glycols include polymers such as polyethylene glycol and polypropylene glycol, ethylene oxide-propylene oxide copolymers, their derivatives, and so forth. Any type of copolymer can be used, for example, a random copolymer, a block copolymer, a graft copolymer, and an alternating copolymer.

Preferred specific examples of the polyalkylene glycol include those expressed by the following formula:

HO—(CₙH₂ₙO)ₘ—H

(where n represents an integer of 1 to 5, and m represents an integer of 1 to 100).

In this formula, (CₙH₂ₙO)ₘ may be a single constant or a combination of two or more numbers as long as the integer n falls within its specified range. For example, if n is 3, the formula gives (C₃H₆O)ₘ, and if n is a combination of 1 and 4, the formula gives (CH₂O—C₄H₈O)ₘ. Also, the integer m may be a single constant or a combination of two or more constants within its specified range. For example, if m is a combination of 20 and 40 in the above-mentioned example, the formula gives (CH₂O)₂₀—(C₂H₄O)₄₀, and if m is a combination of 10 and 30, the formula gives (CH₂O)₁₀—(C₄H₈O)₃₀. Note that every combination of the integers n and m is allowed as long as the integers fall within their respective specified ranges.

Examples of saccharides include monosaccharides such as pentoses, hexoses, heptoses, and octoses, polysaccharides such as disaccharides, trisaccharides, and tetrasaccharides, their derivatives including reduced derivatives such as sugar alcohols and deoxy acids, oxidized derivatives such as aldonic acids and uronic acids, and dehydrated derivatives such as glycoseens, amino acids, thio sugars, and so forth. The term “polysaccharides” refers to sugars in a broad sense and thus includes common naturally occurring substances such as alginic acid, dextrin, and cellulose.

The above-described glossy ink composition preferably contains one or more kinds of acetylene glycol surfactants and/or one or more kinds of silicone surfactants. The surfactant(s) is added preferably at a concentration in the range of 0.01 mass to 10 mass %, both inclusive, relative to the content of the pigment in the ink composition.

Such a preferred configuration would assist the glossy ink composition in wetting a recording medium, thereby contributing to rapid adhesion.

Examples of preferred acetylene glycol surfactants include Surfynol 465 (trademark) and Surfynol 104 (trademark) (trade names, manufactured by Air Products and Chemicals, Inc.) and Olfine STG (trademark) and Olfine E1010 (trademark) (trade names, manufactured by Nissin Chemical Industry Co., Ltd.).

The silicone surfactant used is preferably a polyester-modified silicone or a polyether-modified silicone. Specific examples include BYK-347, BYK-348, BYK-UV3500, BYK-UV3510, BYK-UV3530, and BYK-UV3570 (BYK Japan KK).

The above-described glossy ink composition can be prepared by a known and commonly used method. An example of applicable methods is as follows: the above-described metallic pigment, a dispersant, and the above-described solvent are mixed; a pigment dispersion is prepared using a ball mill, a bead mill, sonication, or a jet mill or by some other means; the pigment dispersion obtained is conditioned to have desired ink properties; then, a binder resin, the above-described solvent, and other additives (e.g., a dispersion aid and a viscosity modifier) are added to the pigment dispersion under stirring, yielding the glossy ink composition.

There are some other possible ways to obtaining the glossy ink composition, for example, a method in which the composite pigment material is sonicated in a solvent, yielding a composite pigment dispersion, and this composite pigment dispersion is mixed with a necessary ink solvent and a method in which the composite pigment material is put directly into the ink solvent and sonicated there.

Although the physical properties of the glossy ink composition are not particularly limited, for example, the surface tension is preferably in the range of 20 to 50 mN/m. With a surface tension of less than 20 mN/m, the ink composition would spread over the head of the ink jet recording printer used while wetting it or exude from it, thereby making it difficult to eject ink droplets. With a surface tension of more than 50 mN/m, the ink composition would be incapable of spreading over the surface of the recording medium used while wetting it, thereby making quality printing impossible in some cases.

The above-described glossy ink composition may further contain such additives as contained in ordinary ink compositions. Examples of applicable additives include, stabilizers (e.g., antioxidants or ultraviolet absorbents).

Examples of applicable antioxidants include BHA (2,3-butyl-4-oxyanisol) and BHT (2,6-di-t-butyl-p-cresol). Examples of applicable ultraviolet absorbents include benzophenone compounds and benzotriazole compounds.

Next, the black ink composition, which is used in the second step of the image recording method according to the present invention, is described.

This black ink composition is used to form a finishing layer on a glossy image produced using the above-described glossy ink composition so that the brightness of the glossy image be reduced. This finishing layer is obtained by applying a black pigment onto the glossy image, which has a metallic luster, at a density low enough to keep the black pigment invisible and is preferably a layer that decreases the brightness of the glossy image layer defined as the L* value in the CIE's L*a*b* chromatic system by 0.5 or more.

This configuration would change the surface properties (surface uniformity) of the glossy image, thereby further improving the gloss of the underlying layer, namely, the glossy image layer.

The black ink composition used in the present invention is an ink composition that contains a black pigment. Examples of black pigments include carbon black (C. Pigment Black 7) such as furnace black, lamp black, acetylene black, and channel black, metals such as copper oxide and iron oxide (C. I. Pigment Black 11), and organic pigments such as aniline black (C. I. Pigment Black 1), with carbon black preferred for the advantages of the present invention. These pigments may be used alone or as a mixture of two or more kinds.

Specific examples of carbon black includes, but not limited to, No. 2300, No. 900, HCF88, No. 33, No. 20B, No. 40, No. 45, No. 52, MA7, MA8, MA100, No2200B and other similar products from Mitsubishi Chemical Corporation, Raven5750, Raven5250, Raven5000, Raven3500, Raven1255, Raven700, and other similar products from Columbian Chemicals Company, Regal400R, Regal330R, Regal660R, Mogul L, Monarch700, Monarch800, Monarch880, Monarch900, Monarch1000, Monarch1100, Monarch1300, Monarch1400, and other similar products from Cabot Corporation, Color BlackFW1, Color BlackFW2, Color BlackFW2V, Color BlackFW18, Color BlackFW200, Color BlackS150, Color BlackS160, Color BlackS170, Printex 35, Printex U, Printex V, Printex 140U, Special Black 6, Special Black5, Special Black 4A, Special Black 4, Special Black250, and other similar products from Degussa GmbH, and so forth.

Although not particularly limited, the particle diameter of carbon black is preferably equal to or smaller than 10 μm, more preferably, equal to or smaller than 0.1 μm.

In the ordinary method for recording an image on a recording medium using a black ink composition, the concentration of the pigment used is on the order of 2 to 8 mass % so that a black color can develop. In the present invention, however, the concentration of the black pigment in the black ink composition is set at 1 mass or less. When the concentration of the black pigment is equal to or lower than 1 mass %, the effect of improving the gloss becomes greater. The concentration is more preferably in the range of 0.1 to 0.5 mass %, in particular, 0.1 to 0.3 mass %.

Then, the black ink composition used in the present invention preferably contains a water-soluble resin. The water-soluble resin contained would improve the closeness of contact between recording media and glossy images, thereby improving the resistance of the images to friction. The term “water-soluble” used herein means that the resin can be dispersed or dissolved in water or an aqueous medium containing water.

Examples of applicable water-soluble resins include water-soluble polymers that have ionic hydrophilic groups derived from alkali metal salts, ammonium salts, inorganic acid salts, organic acid salts, and other similar salts of a sulfonic acid group, a carboxylic acid group, an amino group, or some other similar group. Specific examples include cellulose derivatives such as carboxymethyl cellulose salts and viscose, natural polymers such as alginic acid salts, gelatin, albumin, casein, gum arabic, tragacanth gum, and lignin sulfonate, starch derivatives such as cationic starch, starch phosphate, and carboxymethyl starch, synthetic polymers such as polyacrylic acid salts, polyvinyl sulfuric acid salts, poly(4-vinylpyridine) salts, polyamides, polyallylamine salts, condensed naphthalene sulfonic acid salts, styrene-acrylic acid salt copolymers, styrene-methacrylic acid salt copolymers, acrylic acid ester-acrylic acid salt copolymers, acrylic acid ester-methacrylic acid salt copolymers, methacrylic acid ester-acrylic acid salt copolymers, methacrylic acid ester-methacrylic acid salt copolymers, styrene-itaconic acid salt copolymers, itaconic acid ester-itaconic acid salt copolymers, vinylnaphthalene-acrylic acid salt copolymers, vinylnaphthalene-methacrylic acid salt copolymers, and vinylnaphthalene-itaconic acid salt copolymers, and so forth.

In addition to those listed above, for example, such water-soluble polyurethane resins as described in Japanese Unexamined Patent Application Publication No. 2006-342323 may also be used as the water-soluble resin.

The water-soluble resin further includes resin emulsions (polymer fine particles). Examples of applicable resin emulsions include the polymer fine particles described in Japanese Unexamined Patent Application Publication No. 2004-225036, which have a hydrophilic moiety and a hydrophobic moiety; the structure may be a monolayer structure, a bilayer structure (a core-shell structure), or any other possible structure. When the polymer fine particles have a core-shell structure, any structure would be allowed as long as it contains two or more different kinds of polymers in separate phases. Examples include a structure in which the shell completely covers the core, a structure in which the shell partially covers the core, a structure in which a part of the polymer serving as the shell forms domains or the like in the polymer serving as the core, and a multilayer structure organized by three or more layers with different compositions, in which one or more layers are sandwiched between the core and the shell.

From the viewpoint of the above-mentioned resistance to friction, the concentration of the water-soluble resin in the black ink composition is preferably at least 20-fold greater than the concentration of the pigment of the black ink composition on the solid content basis. More preferably, the above-mentioned ratio of the water-soluble resin is in the range of 20-fold to 50-fold.

In addition, the black ink composition may contain such known additives as described above. Examples of applicable additives include dispersants, stabilizers, solvents, and so forth.

In the image recording method according to the present invention, an intermediate layer may be formed on the above-described glossy image layer using a chromatic ink composition, a white ink composition, a black ink composition, or the like between the first step for forming the glossy image layer and the second step for forming the finishing layer unless the intermediate layer masks the gloss.

The formation of the glossy image layer, the formation of the finishing layer, and the formation of the intermediate layer are preferably based on the ink jet recording method described later. Also, the finishing layer may partially or completely cover the gloss image depending on the resulting image desired. From the viewpoint of improving the closeness of contact between the glossy image layer and the recording medium used, it is desirable that the finishing layer cover the entire surface of the glossy image layer.

No particular limitation is imposed on the recording medium used. Examples of recording media used include plain paper, ink jet paper (matt paper and glossy paper), glass, films made of plastics such as vinyl chloride, films made by coating a substrate with a plastic material or an absorbing layer, metals, printed circuit boards, and many other kinds of recording media.

### [Ink Jet Recording Method]

The ink jet recording method used in the present invention is a kind of ink jet recording method in which an ink jet head is driven to eject droplets of ink compositions onto a recording medium, thereby producing a record, and involves the use of the above-described ink compositions for image formation.

Examples of methods for ejecting ink compositions include the following ones.

The first method is electrostatic attraction. This method produces records in any one of the following ways: a strong electric field is applied between a nozzle and acceleration electrodes disposed in front of the nozzle, so that ink droplets are continuously ejected from the nozzle, and then, while printing information signals are being supplied to deflection electrodes, the ink droplets travel between the deflection electrodes, yielding a record; or ink droplets are ejected without being deflected when the printing information signals control the ejection.

The second method is a method in which fluid ink is pressurized using a small pump, and a nozzle is mechanically oscillated using a quartz oscillator or by some other means, so that ink droplets are forcedly ejected. The ink droplets ejected are electrically charged at the same time as the ejection, and then, while printing information signals are being supplied to deflection electrodes, the ink droplets travel between the deflection electrodes, yielding a record.

The third method is a method involving the use of a piezoelectric element (a piezo element), in which the piezoelectric element simultaneously gives pressure and printing information signals to fluid ink, so that ink droplets are ejected, yielding a record.

The fourth method is a method in which thermal energy is used to make fluid ink rapidly expand. In this method, fluid ink is heated using microelectrodes, which are under the control of printing information signals, until it forms bubbles, so that ink droplets are ejected, yielding a record.

The above-described methods can all be used for the ink jet recording method according to this embodiment. From the viewpoint of high-speed printing, it is preferable that ink compositions be ejected without being heated. In other words, the first, second, and third methods of those described above are preferable.

Incidentally, the ejection rate for the finishing layer, which contains the black ink composition, is preferably in the range of 0.1 gram to 20 grams per square meter, more preferably, 0.2 gram to 5 grams per square meter.

When the above-described recording medium has no ink-absorbing layer, however, it is preferable that the recording medium be heated during printing from the viewpoint of speeding up drying and obtaining better gloss.

Examples of applicable heating methods include one in which a heat source heats the recording medium used by coming into contact with it, ones in which the recording medium used is irradiated with infrared rays, microwaves (electromagnetic waves whose wavelength maxima are at around 2,450 MHz), or the like, blown by hot air, or by some other non-contact means, and so forth.

This heating process is preferably performed before printing and/or at the same time as printing and/or after printing. In other words, the heating of the above-described recording medium may be performed before printing, at the same time as printing, or after printing or even throughout the printing operation. Depending on the kind of recording medium, the heating temperature is preferably in the range of 30 to 80° C., more preferably, 40 to 60° C. Heating is not always necessary; just supplying air using a fan or the like has some effect.

### [Records]

Records according to this embodiment are those recorded using the image recording method according to the present invention, preferably, the above-described ink jet recording method. Such records, obtained using the image recording method according to the present invention, have an excellent gloss; they also have an improved closeness of contact with the recording medium used, thus having an excellent resistance to friction.

### [Image Recording System]

The image recording system according to the present invention features glossy image formation means for recording a glossy image layer on a recording medium using a glossy ink composition containing a metal pigment and finishing layer formation means for recording a finishing layer on the glossy image layer using a black ink composition to reduce the brightness of the glossy image. This image recording system may be a unit that incorporates the glossy image formation means and the finishing layer formation means therein or a system that contains both the means as separate units (e.g., an ink jet recording apparatus is used for recording, and then another ink jet recording apparatus is used to form the finishing layer).

### EXAMPLES

Hereinafter, the present invention is further described with reference to examples thereof; however, it is never limited to these examples.

### (1) Preparation of a Metallic Pigment Dispersion

A resin-layer coating liquid containing 3.0 mass % of cellulose acetate butyrate (butylation rate: 35 to 39%; manufactured by Kanto Chemical Co., Inc.) and 97 mass % of diethylene glycol diethyl ether (manufactured by Nippon Nyukazai Co., Ltd.) was uniformly applied by bar coating onto a polyethylene terephthalate (PET) film with a thickness of 100 μm and was dried at 60° C. for ten minutes, yielding a thin resin layer on the PET film.

Then, an aluminum layer was deposited on the resin layer, using a vacuum deposition apparatus (VE-1010 vacuum deposition apparatus; manufactured by Vacuum Device Inc.), to an average thickness of 20 nm.

Then, the laminate formed in the above-described way was subjected to simultaneous delamination, pulverization, and dispersion in diethylene glycol diethyl ether using an ultrasonic dispersion apparatus VS-150 (manufactured by AS ONE Corporation) for a total ultrasonic dispersion time of 12 hours, yielding a metallic pigment dispersion.

The metallic pigment dispersion obtained was filtered through an SUS mesh filter having a mesh size of 5 μm for removal of coarse particles. Then, the filtrate was poured into a round-bottom flask, where diethylene glycol diethyl ether was distilled out using a rotary evaporator; thus, the metallic pigment dispersion was concentrated. Then, the concentration of the metallic pigment dispersion was adjusted, so that a metallic pigment dispersion was obtained with a concentration of 5 mass %.

Subsequently, the 50% average particle size R50 based on the circle-equivalent diameter in the major axis (X direction)-minor axis (Y direction) plane and the average thickness Z of the metallic pigment were measured using a particle size/particle distribution analyzer (FPIA-3000S; manufactured by Sysmex Corporation); then, R50/Z was calculated from the measurements of R50 and Z. The result was as follows: The 50% average particle diameter, R50, was 1.03 μm, the average thickness, Z, was 0.02 μm, and R50/Z was 51.5.

### (2) Preparation of a Glossy Ink Composition

A glossy ink composition was prepared from the metallic pigment dispersion prepared by the above-described method in accordance with the composition shown in Table 1. A solvent and additives were mixed, and the additives were dissolved in the solvent, yielding an ink solvent, to which the metallic pigment dispersion was added. Then, the components combined were mixed and stirred using a magnetic stirrer at room temperature and pressure for 30 minutes, yielding a glossy ink composition (S1).

In Table 1, diethylene glycol diethyl ether (DEGDE) and dipropylene glycol dibutyl ether (DPGBE) were products manufactured by Nippon Nyukazai Co., Ltd. N-2043-AF-1 (a polyacrylic polyol resin emulsion) was a product manufactured by Harima Chemicals, Inc., and BYK-3500 (a surfactant) was a product manufactured by BYK Japan KK. Note that in this table, the values are expressed in mass %.

TABLE 1

| Ink composition | |
|---|---|
| (glossy ink composition S1) | Concentration (mass %) |
| DEGDE | 47.8 |
| DPGBE | 45.0 |
| N-2043-AF-1 | 6.0 |
| BYK-3500 | 0.2 |
| Inorganic solid matter | 1.0 |

### (3) Preparation of a Black Ink Composition

The ingredients listed in Table 2 below were mixed and then dispersed with glass beads [diameter=1.7 mm; weighing 1.5-times the quantity (mass) of the mixture] in a sand mill (manufactured by Yasukawa Seisakusho) for two hours, yielding a black ink composition.

TABLE 2

| Ink composition | |
|---|---|
| (black ink composition) | Concentration (mass %) |
| Carbon black | 0.21 |
| Water-soluble resin 1 | 0.24 |
| Water-soluble resin 2 | 5.0 |
| Water-soluble resin 3 | 20.0 |
| Glycerin | 18.0 |
| 1,2-Hexanediol | 5.0 |
| Triethanolamine | 0.9 |
| BYK-348 | 0.5 |
| EDTA | 0.02 |
| Pure water | Balance |

The following lists some of the ingredients contained in the black ink composition according to Table 2.

Carbon black: A product from Mitsubishi Chemical Corporation; trade name: MA8

Water-soluble resin 1 (a dispersant): A styrene acrylic resin

Water-soluble resin 2: A polypropylene emulsion (manufactured by BYK Japan KK; Trade name: AQUACER593; solid content: 30 mass %)

Water-soluble resin 3: Polyurethane (manufactured by Mitsui Polyurethane, Inc.; Trade name: W6061; solid content: 15 mass %)

BYK-348: A polysiloxane surfactant (manufactured by BYK Japan KK)

### (4) Print Evaluation Test

As a test printer, an ink jet printer PX-5500 (manufactured by Seiko Epson Corporation) was used. The slot to insert a black ink cartridge into was filled and mounted with the above-described glossy ink composition S1, whereas the slot to insert a light-black ink cartridge into was filled and mounted with the above-described black ink composition. The recording medium used was photographic paper (manufactured by Seiko Epson Corporation). The recording resolution was always set at 1440×720 dpi. The recording duty was set at 100% for the glossy ink composition S1 and 20% for the black ink composition.

Here, “duty” is a value calculated from the following equation:

Duty(%)=Number of dots printed/(Vertical resolution×Horizontal resolution)×100

(where the “number of dots printed” is the number of dots printed per unit area, and “vertical resolution” and “horizontal resolution” are individually a resolution per unit area. A duty of 100% represents the maximum mass of ink per color for a single pixel.)

First, the glossy ink composition S1 was printed on the recording medium for the evaluation of the resistance to friction of the glossy image obtained. The result was as follows: The glossy image did not adhere to the recording medium and was easily removed upon being touched.

Then, the brightness (L* value in the CIE's L*a*b* chromatic system) was evaluated. The L* value in the CIE's L*a*b* chromatic system was measured using Gretag Macbeth Spetroscan and Spectrolino (manufactured by X-Rite, Incorporated).

The result was as follows: the L* value was 40.3 for a print produced on the recording medium only with the glossy ink composition S1 and 38.2 for a print produced by further printing the black ink composition. The L* value in the CIE's L*a*b* chromatic system for the glossy image dropped when the black ink composition was printed, and thus the gloss was better on the glossy image itself than on that covered with a finishing layer, namely, the black ink composition. Additionally, the closeness of contact between the glossy image and the recording medium was confirmed, and the resistance to friction was also confirmed.

1. An image recording method comprising a first step for recording a glossy image layer on a recording medium using a glossy ink composition containing a metal pigment and a second step for recording a finishing layer on the glossy image layer using a black ink composition to reduce the brightness of the glossy image.

2. The image recording method according to claim 1, wherein the concentration of pigment of the black ink composition is equal to or lower than 1 mass %.

3. The image recording method according to claim 2, wherein the concentration of pigment of the black ink composition is in the range of 0.1 to 0.5 mass %.

4. The image recording method according to claim 1, wherein the black ink composition contains a water-soluble resin.

5. The image recording method according to claim 4, wherein the concentration of water-soluble resin in the black ink composition is at least 20-fold greater than the concentration of pigment of the black ink composition on the solid content basis.

6. The image recording method according to claim 1, wherein the finishing layer is formed on at least a partial surface of the glossy image layer.

7. The image recording method according to claim 6, wherein the finishing layer is formed on the entire surface of the glossy image layer.

8. The image recording method according to claim 1 performed using an ink jet recording method.

9. A record obtained using the image recording method according to claim 1.

10. An image recording system comprising glossy image formation means for recording a glossy image layer on a recording medium using a glossy ink composition containing a metal pigment and finishing layer formation means for recording a finishing layer on the glossy image layer using a black ink composition to reduce the brightness of the glossy image.
